(19) United States
(12) Patent Application Publication
(10) Pub. No.: US 2022/0050687 A1
(43) Pub. Date: Feb. 17, 2022

(54) METHOD OF BOOTING ELECTRONIC DEVICE AND ELECTRONIC DEVICE CONTROL SYSTEM, METHODS OF OPERATING AND CONTROLLING ELECTRONIC DEVICE, ELECTRONIC DEVICE, CONTROL TERMINAL, AND ELECTRONIC DEVICE CONTROL SYSTEM

(71) Applicants: K-TRONICS (SUZHOU) TECHNOLOGY CO., LTD., Suzhou, Jiangsu (CN); BOE TECHNOLOGY GROUP CO., LTD., Beijing (CN)

(72) Inventor: Chao ZENG, Beijing (CN)

(21) Appl. No.: 16/499,796

(22) PCT Filed: Mar. 25, 2019
(86) PCT No.: PCT/CN2019/079513

§ 371 Date: Sep. 30, 2019

(30) Foreign Application Priority Data
Mar. 26, 2018 (CN) 201810253328.2

(51) Int. Cl. G06F 9/4401; G06K 7/14; H04N 21/443

(52) U.S. Cl. CPC G06F 9/4401; H04N 21/4436; H04N 21/4432; G06K 7/1417

(57) ABSTRACT

A method of booting an electronic device, methods of operating and controlling an electronic device, an electronic device, a control terminal, and an electronic device control system. The method of booting the electronic device includes: displaying a first graphic code on a screen of the electronic device, each of the first graphic codes corresponding to a preset booting instruction; scanning, by a first control terminal, the first graphic code, and transmitting a booting request of the electronic device to a second control terminal according to the first graphic codes; generating, by the second control terminal, a booting command of the electronic device according to the booting request, and transmitting the booting command to the electronic device; determining, by the electronic device, a turning-on time length of the electronic device according to a matching result between the booting command and the preset booting instruction.

### CROSS REFERENCE TO RELATED APPLICATIONS

The present application claims priority to Chinese Patent Application No. 201810253328.2, filed on Mar. 26, 2018, the disclosure of which is incorporated herein by reference in its entirety as part of the present application.

### TECHNICAL FIELD

Embodiments of the present disclosure relate to a method of booting an electronic device and an electronic device control system, methods of operating and controlling an electronic device, an electronic device, a control terminal, and an electronic device control system.

### BACKGROUND

Watching TV programs is a popular indoor entertainment activity, and with the requirements of users increase, many functions are gradually added to the television to meet different requirements. The timing function of the television is one of the added functions, and the user may set the television's on/off time by pressing a button or by remote control.

### SUMMARY

At least one embodiment of the present disclosure provides a method of booting an electronic device, the method comprising:

displaying a first graphic code on a screen of the electronic device, each of the first graphic code corresponding to a preset booting instruction;

scanning, by a first control terminal, the first graphic code, and transmitting, by the first control terminal, a booting request of the electronic device to a second control terminal according to the first graphic code;

generating, by the second control terminal, a booting command of the electronic device according to the booting request, and transmitting, by the second control terminal, the booting command to the electronic device; and

determining, by the electronic device, a turning-on time length of the electronic device according to a matching result between the booting command and the preset booting instruction.

At least one embodiment of the present disclosure further provides a method of booting an electronic device, the method comprising:

obtaining, by a first control terminal, a first graphic code of the electronic device from a second control terminal; and

scanning, by electronic device, the first graphic code of the first control terminal by using a camera, and determining, a turning-on time length of the electronic device according to a matching result between the first graphic code and a second graphic code stored in the electronic device.

At least one embodiment of the present disclosure further provides an electronic device control system, the system comprising an electronic device, a first control terminal, and a second control terminal:

the electronic device is configured to display a first graphic code on a screen, each of the first graphic codes corresponding to a preset booting instruction;

the first control terminal is configured to scan the first graphic code on the screen, and transmit a booting request of the electronic device to the second control terminal according to the scanned first graphic code;

the second control terminal generates a booting command of the electronic device according to the received booting request, and transmits the booting command to the electronic device; and

the electronic device is further configured to determine a turning-on time length according to a matching result between the booting command and the preset booting instruction.

At least one embodiment of the present disclosure further provides an electronic device control system, comprising an electronic device, a first control terminal, and a second control terminal:

the first control terminal is configured to obtain a first graphic code of the electronic device from the second control terminal;

the electronic device is configured to scan the first graphic code of the first control terminal by using an imaging device, and to determine, according to a matching result between the first graphic code and a second graphic code stored in the electronic device, a turning-on time length of the electronic device.

At least one embodiment of the present disclosure further provides a method of operating an electronic device, comprising:

obtaining graphic code information about a predetermined operation of the electronic device;

obtaining instruction information about the predetermined operation of the electronic device; and

operating the electronic device according to a matching result between the graphic code information and the instruction information.

At least one embodiment of the present disclosure further provides a method of controlling an electronic device, comprising:

receiving a request from a first control terminal;

providing, according to the request from the first control terminal, a first graphic code to the first control terminal so that the first control terminal provides graphic code information to the electronic device, wherein the first graphic code comprises the graphic code information, and the graphic code information is about a predetermined operation of the electronic device; or

providing, according to the request from the first control terminal, instruction information to the electronic device, wherein the request is based on the first graphic code including the graphic code information about the predetermined operation of the electronic device.

At least one embodiment of the present disclosure further provides an electronic device, comprising:

a processor; and

a memory,

wherein the memory stores computer readable instructions executable by the processor, and the computer readable instructions, when executed, cause the processor to perform operations comprising:

obtaining graphic code information about a predetermined operation of the electronic device;

obtaining instruction information about the predetermined operation of the electronic device; and

operating the electronic device according to a matching result between the graphic code information and the instruction information.

At least one embodiment of the present disclosure further provides a control terminal, comprising:

a processor; and

a memory,

wherein the memory stores computer readable instructions executable by the processor, and the computer readable instructions, when executed, cause the processor to perform operations comprising:

receiving a request from a first control terminal;

providing, according to a request from the first control terminal, a first graphic code to the first control terminal so that the first control terminal provides graphic code information to an electronic device, wherein the first graphic code comprises the graphic code information, and the graphic code information is about a predetermined operation of the electronic device; or

providing, according to the request from the first control terminal, instruction information to the electronic device, wherein the request is based on the first graphic code including the graphic code information about the predetermined operation of the electronic device.

At least one embodiment of the present disclosure further provides an electronic device control system comprising the electronic device as described above and the control terminal as described above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flow chart of a method of booting a television provided by at least some embodiments of the present disclosure;

FIG. 2 is a flow chart of another method of booting a television provided by at least some embodiments of the present disclosure;

FIG. 3 is a flow chart of another method of booting a television provided by at least some embodiments of the present disclosure;

FIG. 4 is a flow chart of another method of booting a television provided by at least some embodiments of the present disclosure.

FIG. 5 is a schematic diagram of a control system of a television provided by at least some embodiments of the present disclosure;

FIG. 6 is a schematic diagram of another control system of a television provided by at least some embodiments of the present disclosure;

FIG. 7 is a schematic diagram of another control system of a television provided by at least some embodiments of the present disclosure;

FIG. 8 is a structural schematic diagram of a computing system suitable for implementing a method of booting a television or a television of at least some embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art may obtain other embodiment(s), without any inventive work, which should be within the scope of the disclosure.

In practically setting the turning-on time length of the television, the user is required to perform multiple selection operations on the menu of the television, and also manually adjust the turning-on time length set in the menu to complete the setting of the turning-on time length. The steps of this setting operation are cumbersome and inconvenient, which reduces the user experience.

At least some embodiments of the present disclosure provide a method of operating an electronic device, which includes:

obtaining graphic code information about a predetermined operation of the electronic device;

obtaining instruction information about the predetermined operation of the electronic device; and

operating the electronic device according to a matching result between the graphic code information and the instruction information.

In some embodiments, the obtaining the graphic code information about the predetermined operation of the electronic device includes obtaining the graphic code information stored in the electronic device,

the method of operating the electronic device further includes providing the graphic code information to a first control terminal,

the obtaining the instruction information about the predetermined operation of the electronic device includes obtaining the instruction information from a second control terminal, wherein the instruction information is generated by the second control terminal based on a request of the first control terminal, and the request is generated by the first control terminal based on the graphic code information,

the operating the electronic device according to the matching result between the graphic code information and the instruction information includes:

comparing the instruction information with preset instruction information corresponding to the graphic code information, and

operating the electronic device based on a result of the comprising.

In some embodiments, the obtaining graphic code information about the predetermined operation of the electronic device includes scanning a graphic code about the predetermined operation of the electronic device on the first control terminal to obtain the graphic code information, and

the obtaining the instruction information about the predetermined operation of the electronic device described above includes obtaining the instruction information stored in the electronic device.

In some embodiments, the graphic code described above is provided by the second control terminal to the first control terminal based on a request by the first control terminal.

In some embodiments, the method of operating the electronic device further includes:

receiving the instruction information transmitted by the cloud in response to a request of the second control terminal; and

storing the instruction information.

In some embodiments, the s operating the electronic device according to the matching result between the graphic code information and the instruction information includes:

performing a predetermined operation corresponding to the graphic code information, in response to the graphic code information matching the instruction information; and

transmitting an error prompt message, in response to the graphic code information not matching the instruction information.

At least some embodiments of the present disclosure provide a method of controlling an electronic device, which includes:

receiving a request from a first control terminal;

providing, according to the request from the first control terminal, a first graphic code to the first control terminal to cause the first control terminal to provide graphic code information to the electronic device, wherein the first graphic code includes the graphic code information and the graphic code information is about a predetermined operation of the electronic device; or

providing, according to the request from the first control terminal, instruction information to the electronic device, wherein the request is based on the first graphic code including the graphic code information about the predetermined operation of the electronic device.

At least some embodiments of the present disclosure also provide an electronic device, a control terminal, and an electronic device control system including the electronic device and the control terminal.

Embodiments of the present disclosure will be described below by taking a television as an example of an electronic device. However, it should be understood that embodiments of the present disclosure are not limited thereto.

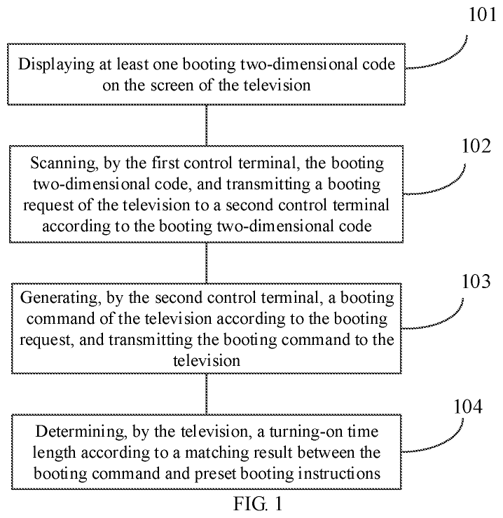

At least some embodiments of the present disclosure provide a method of booting a television. Referring to FIG. 1, the method mainly includes:

101. Displaying at least one booting two-dimensional code on the screen of the television.

After a user switches on the television, the booting two-dimensional code(s) is displayed on the screen of the television. The booting two-dimensional code(s) corresponds to a preset booting instruction(s), and the preset booting instruction(s) includes at least the turning-on time length of the television. It should be understood that the preset booting instruction(s) including the turning-on time length of the television is only an example of the preset booting instruction(s) corresponding to the turning-on time length of the television, and embodiments of the present disclosure are not limited thereto. Furthermore, in order to facilitate the management and reading of data, a two-dimensional code picture library may be preset in the television, and the television generates the booting two-dimensional code(s) according to the preset turning-on time length, and then stores the generated booting two-dimensional code(s) in the two-dimensional code picture library of the television. When the television enters the standby mode after being switched on, a plurality of booting two-dimensional codes of the two-dimensional code picture library are displayed on the standby screen, and the user may scan a corresponding two-dimensional code according to required turning-on time length. Furthermore, a booting data storage area may be preset in the television, and the preset booting instruction(s) is generated according to the preset turning-on time length for generating the booting two-dimensional code(s) so that the preset booting instruction(s) corresponds to the booting two-dimensional code(s). The generated preset booting instruction(s) is then stored in the booting data storage area for subsequent comparison with the booting command(s) received by the television. The television includes but is not limited to a smart television, and the type of the television in the embodiment is not limited. It should be understood that the booting two-dimensional code mentioned in the embodiment of the present disclosure is an example of the first graphic code described above, and embodiments of the present disclosure are not limited thereto.

Obtaining, by the television, the booting two-dimensional code stored in the television is an example of obtaining graphic code information about the predetermined operation of the electronic device as described above.

Step 101 is an example of the step of providing the graphic code information to the first control terminal.

In some embodiments, step 101 may include: displaying the at least one booting two-dimensional code on a turning-on time length selection page of the television, wherein each of the at least one booting two-dimensional code corresponds to the turning-on time length of the television that is set uniquely.

102. Scanning, by the first control terminal, the booting two-dimensional code, and transmitting a booting request of the television to a second control terminal according to the booting two-dimensional code.

In some embodiments, step 102 may include: scanning, by the first control terminal, one of the at least one booting two-dimensional code, and transmitting, by the first control terminal, a booting request of the television to the second control terminal according to the one of the at least one booting two-dimensional code.

The first control terminal may be a terminal device such as a mobile phone or a tablet computer. The following description is made by taking a mobile phone as an example, but the type of the first control terminal is not limited by the present embodiment. The second control terminal may be a terminal device such as a mobile phone, a tablet computer, or a desktop computer. The following description is made by taking a mobile phone as an example, but the type of the second control terminal is not limited by the present embodiment.

The user selects the corresponding booting two-dimensional code on the screen according to the required turning-on time length, and scans the booting two-dimensional code by a user mobile phone, and then the user mobile phone generates a corresponding booting request according to the scanned booting two-dimensional code. Because the booting two-dimensional code carries the turning-on time length requested by the user, the booting request generated according to the booting two-dimensional code also includes the turning-on time length requested by the user. It should be understood that the case where the booting two-dimensional code carries the turning-on time length requested by the user is only an example in which the booting two-dimensional code corresponds to the turning-on time length of the television, and embodiments of the present disclosure are not limited thereto. In addition, it should be understood that the booting request including the turning-on time length requested by the user is only an example of the booting request corresponding to the turning-on time length of the television, and embodiments of the present disclosure are not limited thereto. After the user mobile phone generates the booting request in the background, the booting request is transmitted to the administrator mobile phone of the television administrator.

Furthermore, the booting two-dimensional code may include only one turning-on time length, or may include a plurality of turning-on time lengths. When the booting two-dimensional code includes a plurality of turning-on time lengths, the request selection page may be set on the user mobile phone. After scanning the booting two-dimensional code, the user may select a turning-on time length from the plurality of turning-on time lengths included in the booting two-dimensional code through the request selection page, and then the user mobile phone generates a booting request according to the selection.

Furthermore, the user mobile phone may transmit a booting request to the corresponding administrator mobile phone according to the information input by the user. The information input by the user may be the mobile phone number of the administrator, the account name of the administrator in the television administration system, and the like. Alternatively, when the booting two-dimensional code carries information on the administrator mobile phone or the administrator, the user mobile phone may transmit the booting request to the corresponding administrator mobile phone according to the information. The information on the administrator mobile phone may be a mobile phone number, the hardware (MAC, media access control) address of the mobile phone, the serial number of the mobile phone, and the like, and the information on the administrator may be the name of the administrator, the account name of the administrator in the television administration system, and the serial number of the administrator, and the like. This embodiment does not specifically limit the information input by the user, the information on the administrator mobile phone, and the information on the administrator.

Furthermore, when an identifier of the television is included in the booting two-dimensional code, the identifier of the television may be added in the booting request, so that the administrator may determine the television that the user requests to turn on after receiving the booting request. Alternatively, the user mobile phone may prompt the user to input the identifier of the television when generating a booting request. The identifier of the television may be the name of the television, the serial number of the television, etc., and the identifier of the television is not limited by the embodiment.

103. Generating, by the second control terminal, a booting command of the television according to the booting request, and transmitting the booting command to the television.

After receiving the booting request, the administrator mobile phone analyzes the booting request, and obtains the turning-on time requested by the user and the television requested to be turned on by the user. A corresponding booting command is generated according to the requested turning-on time length in the received booting request so that the booting command includes the turning-on time length requested by the user. After the booting command is generated, the administrator mobile phone transmits the booting command to the corresponding TV. It should be understood that the booting command including the turning-on time length requested by the user is only an example of the booting command corresponding to the turning-on time length of the television, and embodiments of the present disclosure are not limited thereto.

Step 103 is an example of the step of providing instruction information to the electronic device according to the request from the first control terminal, wherein the booting command is an example of the instruction information described above.

104. Determining, by the television, a turning-on time length according to a matching result between the booting command and preset booting instructions.

The television compares the received booting command with the preset booting instructions in the data storage area, executes the booting command to turn on the play mode after determining that the received booting command matches any of the preset booting instructions, and plays television programs within the turning-on time length requested by the user. Furthermore, in order to facilitate management of data, a temporary data storage area is preset in the television, and the received booting command is stored in the temporary data storage area.

It should be understood that receiving, by the television, the booting command from the second control terminal is an example of the above-described step of obtaining instruction information about the predetermined operation of the electronic device.

Furthermore, step 104 is an example of the step of operating the electronic device according to the matching result between the graphic code information and the instruction information. The preset booting instruction is an example of the above-described preset instruction information.

Furthermore, it should be understood that determining the turning-on time length is an example of operating an electronic device, and embodiments of the present disclosure are not limited thereto.

According to the method of booting the television provided by at least some embodiments of the present disclosure, in order to improve the efficiency of setting the on/off time of the television by the user, a plurality of booting two-dimensional codes including different turning-on time lengths of the television that may be preset are stored in the television; when the user needs to turn on the television, the user may select and scan the corresponding booting two-dimensional code on the television screen through the terminal (i.e., the first control terminal), such as the first control terminal, according to the watching time length required by the user, and then the user mobile phone may generate a corresponding booting request according to the booting two-dimensional code; and then, the terminal (i.e., the second control terminal), such as a mobile phone of the television administrator, generates a specified booting command according to the booting request to control the television to be turned on and sets the turning-on time length of the television that meets the requirements of the user.

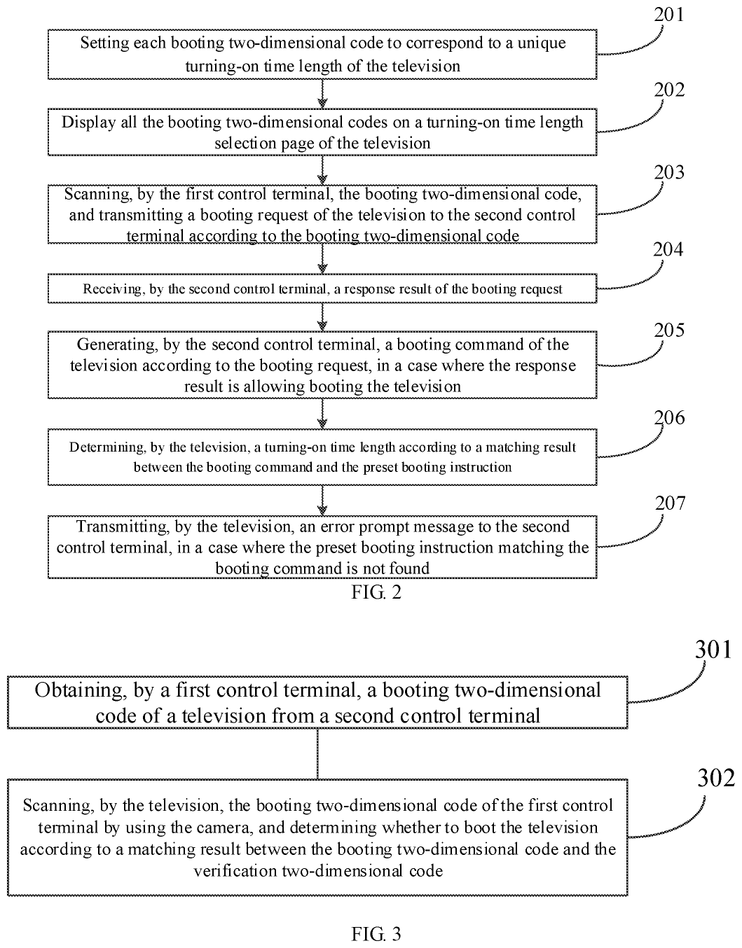

At least some embodiments of the present disclosure also provide another method of booting a television. Referring to FIG. 2, the method mainly includes:

201. Setting each booting two-dimensional code to correspond to a unique turning-on time length of the television.

In order to simplify the operation steps and reduce the user's selection error, one booting two-dimensional code is generated for each turning-on time length so that one booting two-dimensional code corresponds to a unique turning-on time length.

202. Display all the booting two-dimensional codes on a turning-on time length selection page of the television.

The standby page of the television is set as the turning-on time length selection page, and all the booting two-dimensional codes are displayed on the turning-on time length selection page, so that the user selects the unique corresponding booting two-dimensional code according to the turning-on time length requested.

Furthermore, if the number of the booting two-dimensional codes to be displayed is large, all the booting two-dimensional codes may be set to be cyclically displayed in turn on the turning-on time length selection page; alternatively, a plurality of turning-on time length selection page may be set, and the plurality of turning-on time length selection page are automatically turned when the booting two-dimensional codes are displayed or turned according to the user selection. Furthermore, the booting two-dimensional codes may be arranged in a preset order on the turning-on time length selection page, and the preset order may be based on the length of the turning-on time length corresponding to the booting two-dimensional code, and the number of times the booting two-dimensional code is selected. In this embodiment, the preset order of the booting two-dimensional code is not specifically limited.

203. Scanning, by the first control terminal, the booting two-dimensional code, and transmitting a booting request of the television to the second control terminal according to the booting two-dimensional code.

The user scans the booting two-dimensional code on the turning-on time length selection page through a user mobile phone, and the user mobile phone generates a booting request according to the unique turning-on time length carried in the scanned booting two-dimensional code, and then transmits the booting request to an administrator mobile phone of the television administrator to request the administrator to allow the television to play programs normally during the requested turning-on time length. It should be understood that the turning-on time length being carried in the booting two-dimensional code is only an example of the booting two-dimensional code corresponding to the turning-on time length of the television, and embodiments of the present disclosure are not limited thereto.

204. Receiving, by the second control terminal, a response result of the booting request.

The response result includes allowing booting the television and denying booting the television. The administrator mobile phone displays the booting request to the administrator after receiving the booting request transmitted by the user, and receives the response result corresponding to the response after the administrator responds to the booting request. For example, after receiving the booting request, the administrator mobile phone analyzes the booting request to obtain the requested turning-on time length, and then displays the user who requests to turn on the television and the turning-on time length requested by the user; the administrator will make a response on the administrator mobile phone according to the displayed data, and the administrator mobile phone receives the response result, and subsequently performs a corresponding operation according to the response result. Alternatively, the administrator mobile phone determines the response result corresponding to the booting request according to a preset judgment strategy; for example, the administrator mobile phone stores a preset judgment strategy, and the judgment strategy records that the user A is allowed to turn on the television; after receiving the booting request transmitted by the user A, the administrator mobile phone determines that the response result corresponding to the booting request is allowing booting the television according to the judgment strategy, and then performs corresponding operations according to the determined response result. This embodiment does not specifically limit the content of the judgment strategy.

When the response result received by the administrator mobile phone is allowing booting the television, step 205 is performed. When the response result is denying booting the television, the administrator mobile phone does not perform any operation according to the received booting request. Furthermore, in order to prevent the user from transmitting an incorrect booting request due to a misoperation or the like, the administrator mobile phone returns a feedback message to the user mobile phone when the received response result is denying booting the television. The feedback message may be a short message, a reminder message in the system or the program, etc., and the content and display form of the feedback message are not specifically limited in this embodiment.

205. Generating, by the second control terminal, a booting command of the television according to the booting request, in a case where the response result is allowing booting the television.

After receiving the response result that allows booting the television, the administrator mobile phone is triggered to generate a corresponding booting command according to the unique turning-on time length in the booting request, and forward the booting command to the television that the user requests to turn on.

Step 205 is an example of providing the instruction information to the electronic device according to the request from the first control terminal.

206. Determining, by the television, a turning-on time length according to a matching result between the booting command and the preset booting instruction.

After receiving the booting command forwarded by the administrator mobile phone, the television compares the booting command with the preset booting instruction. The booting two-dimensional code is in one-to-one correspondence with the preset booting instruction, and the booting command generated by scanning the booting two-dimensional code is also in one-to-one correspondence with the preset booting instruction; therefore, if the same preset booting instruction as the booting command is found, the turning-on time length of the television is determined according to the turning-on time length carried in the booting command. It should be understood that the booting command carrying the turning-on time length is only an example of the booting command corresponding to the turning-on time length of the television, and embodiments of the present disclosure are not limited thereto.

207. Transmitting, by the television, an error prompt message to the second control terminal, in a case where the preset booting instruction matching the booting command is not found.

For example, in some embodiments, step 207 may include transmitting, by the television, an error prompt message to the second control terminal, in response to the booting command not matching the preset booting instruction.

If the same preset booting instruction as the booting command is not found, the booting command received by the television is an incorrect command and cannot be executed. In order to make it easy for the administrator to collect statistics on whether the booting command is executed, the television will transmit an error prompt message to the administrator mobile phone when the booting command cannot be executed. The error prompt message may be a short message, a reminder message in a system or a program, etc., and the content and display form of the error prompt message are not specifically limited in this embodiment.

Steps 206 and 207 are examples of operating the electronic device according to the matching result between the graphic code information and the instruction information.

Furthermore, in order to prevent the user from transmitting an incorrect booting request due to a misoperation, the administrator mobile phone may transmit a feedback message to the corresponding mobile phone of the user after receiving the error prompt message transmitted by the television, so as to remind the user to check whether the sent booting request is correct.

According to the method of booting a television provided by at least some embodiments of the present disclosure, in order to simplify the operation steps and reduce the user's selection error, one booting two-dimensional code is set to correspond to the unique turning-on time length, and all the booting two-dimensional codes are displayed on the turning-on time length selection page of the television. After obtaining the booting request of the user, the second control terminal may determine, according to the received response result of the request, whether to generate a booting command for the booting request. When the received response result is allowing booting the television, the booting command is generated according to the currently received booting request. Moreover, the television may also transmit an error prompt message to the second control terminal when the received booting command does not match the preset booting instruction, so as to remind the administrator that the incorrect command is sent.

At least some embodiments of the present disclosure also provide a method of booting a television. Referring to FIG. 3, the method mainly includes:

301. Obtaining, by a first control terminal, a booting two-dimensional code of a television from a second control terminal.

In a case where the television has a camera, when the user presents the booting two-dimensional code of the television, the television scans the booting two-dimensional code, and determines whether to turn on the television for the user by verifying the booting two-dimensional code. The following description is made by taking the case where the first control terminal is a mobile phone and the second control terminal is a computer as an example. The above-described camera is only an example of an imaging device of the television, and embodiments of the present disclosure are not limited thereto.

When wishing to turn on the television, the user first needs to ask the administrator for the booting two-dimensional code corresponding to the requested turning-on time length of the television, that is, the user obtains the corresponding booting two-dimensional code from the administrator computer through the user mobile phone. The booting two-dimensional code in the administrator computer corresponds to the verification two-dimensional code stored in the television, so that the television may subsequently determine whether the user has the authority to use the television according to the booting two-dimensional code. The obtained booting two-dimensional code includes at least the turning-on time length of the television, and because the turning-on time length is the turning-on time length requested by the user, the television may subsequently obtain the turning-on time length requested by the user according to the booting two-dimensional code after verifying the user's authority. It should be understood that the booting two-dimensional code including the turn-on time length of the television is only an example of the booting two-dimensional code corresponding to the turning-on time length of the television, and embodiments of the present disclosure are not limited thereto. Furthermore, the verification two-dimensional code mentioned in the embodiment of the present disclosure is an example of the above-described second graphic code, however, the embodiment of the present disclosure is not limited thereto.

Providing, by the administrator computer, the booting two-dimensional code to the user mobile phone according to the request of the user mobile phone is an example of the step of providing the first graphic code to the first control terminal according to the request from the first control terminal.

Furthermore, when obtaining the booting two-dimensional code, the user mobile phone may transmit a booting request to the administrator computer so that the administrator's computer returns a corresponding booting two-dimensional code to the user mobile phone according to the booting request.

302. Scanning, by the television, the booting two-dimensional code of the first control terminal by using the camera, and determining the turning-on time length of the television according to a matching result between the booting two-dimensional code and the verification two-dimensional code.

In some embodiments, determining, according to the matching result between the booting two-dimensional code and the verification two-dimensional code, the turning-on time length of the television, includes: determining whether to turn on the television according to the matching result between the booting two-dimensional code and the verification two-dimensional code.

The user mobile phone displays the obtained two-dimensional code to the television, and the television scans the screen of the user mobile phone by the camera to obtain the booting two-dimensional code. Then, the obtained booting two-dimensional code is compared with the stored verification two-dimensional code. If the obtained two-dimensional code is the same as any of the verification two-dimensional codes, it is determined that matching is successful, and the television needs to be turned on for the user. If the verification two-dimensional code which is the same as the obtained two-dimensional code is not found, it is determined that matching fails, and the television should not be turned on.

Scanning, by the television, the booting two-dimensional code of the first control terminal by using the camera is an example of the above-described step of obtaining graphic code information about the predetermined operation of the electronic device.

Obtaining, by the television, the stored verification two-dimensional code is an example of the above-described step of obtaining instruction information regarding the predetermined operation of the electronic device.

According to the method of booting the television provided by at least some embodiments of the present disclosure, in order to improve the efficiency of setting the on/off time of the television by the user, when the user wishes to turn on the television, the user may obtain the corresponding booting two-dimensional code by communicating with the second control terminal through the first control terminal according to the watching time required by the user, and then the booting two-dimensional code is scanned and verified by the television, and after the booting two-dimensional code is successfully verified by the television, the turning-on time length of the television that meets the user's demand may be set according to the turning-on time length corresponding to the booting two-dimensional code.

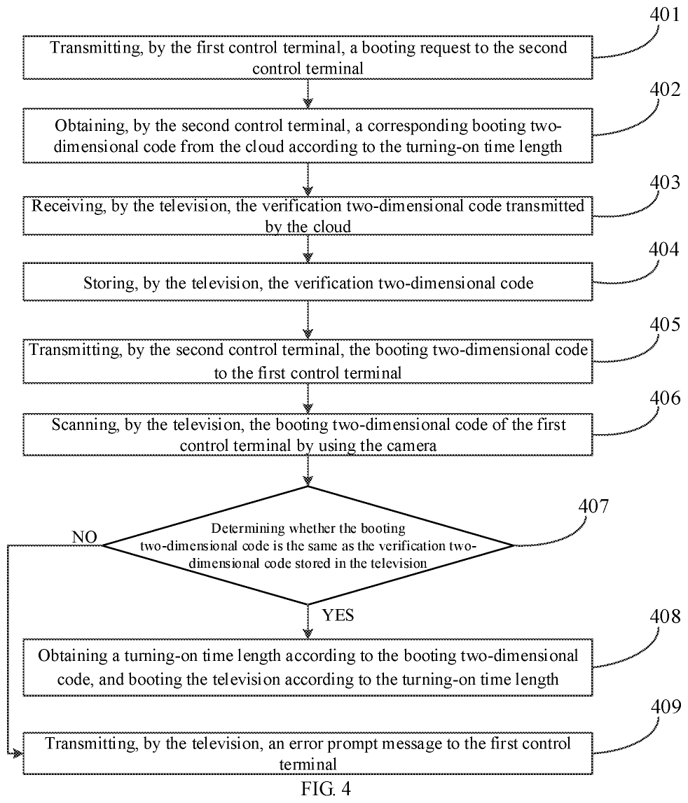

At least some embodiments of the present disclosure also provide another method of booting a television. Referring to FIG. 4, the method mainly includes:

401. Transmitting, by the first control terminal, a booting request to the second control terminal.

In order to obtain the booting verification code, the user mobile phone generates a booting request according to the requested turning-on time length, and transmits the booting request to the administrator computer. Furthermore, the user mobile phone may add the information of the television in the booting request according to the information input by the user; alternatively, when the television two-dimensional code is set on the television, the user mobile phone may obtain the information of the television by scanning the television two-dimensional code, and add the information of the television to the booting request, so that the administrator may determine the television that the user requests to turn on according to the booting request.

Furthermore, the user mobile phone may transmit the booting request to the corresponding administrator computer according to the information input by the user; the information input by the user may be the MAC address of the administrator's computer, the email address in the administrator computer, and the account name of the administrator in the television administration system, and the like. Alternatively, when the administration two-dimensional code of the administrator computer or the administrator's information is set on the television, the user mobile phone may obtain the information of the administrator computer or the administrator by scanning the administration two-dimensional code, and transmit the generated booting two-dimensional code to the corresponding administrator computer according to the obtained information. The information of the administrator computer may be the MAC address of the administrator's computer, the email address in the administrator's computer, and the like, and information of the administrator may be the name of the administrator, the account name and serial number of the administrator in the television administration system, and the like. The present embodiment does not specifically limit the content of the information input by the user, the information of the administrator's computer, and the administrator's information.

402. Obtaining, by the second control terminal, a corresponding booting two-dimensional code from the cloud according to the turning-on time length.

In order not to occupy the storage space of the administrator computer, and thus not affecting its response speed, the television's booting two-dimensional code is stored at the cloud. After receiving the booting request transmitted by the user mobile phone, the administrator computer determines whether it is necessary to return the booting two-dimensional code to the user mobile phone according to the response result of the administrator to the booting request or according to the corresponding response result in the preset judgment strategy. If it is determined that the booting two-dimensional code is required to be returned, the booting two-dimensional code corresponding to the turning-on time length is obtained from the cloud according to the turning-on time length requested in the booting request. If it is determined that the booting two-dimensional code is refused to be returned, a feedback message is transmitted to the corresponding user mobile phone to remind the user that the request has been denied and the television cannot be turned on.

Furthermore, the dynamic two-dimensional code database of the cloud stores the booting two-dimensional codes corresponding to all the turning-on time length, and the booting two-dimensional codes are in one-to-one correspondence with the turning-on time length. After determining that the booting two-dimensional code is required to be returned, the administrator computer generates an obtaining request according to the turning-on time length requested by the user, and then transmits the obtaining request to the cloud so that the cloud returns the corresponding booting two-dimensional code.

Furthermore, the administrator computer may transmit the information of the television requested to be turned on by the user to the cloud together with the obtaining request, so that the cloud may subsequently transmit a verification two-dimensional code to the corresponding television according to the information of the television.

403. Receiving, by the television, the verification two-dimensional code transmitted by the cloud.

When transmitting the booting two-dimensional code to the administrator computer, the cloud transmit the booting two-dimensional code to the corresponding TV as the verification two-dimensional code, so that the television may subsequently verify whether the two-dimensional code provided by the user mobile phone is correct according to the verification two-dimensional code.

Step 403 is an example of the step of obtaining instruction information about the predetermined operation of the electronic device.

404. Storing, by the television, the verification two-dimensional code.

The data temporary storage area is preset in the television. After receiving the verification two-dimensional code transmitted by the cloud, the television will store the verification two-dimensional code in the data temporary storage area.

405. Transmitting, by the second control terminal, the booting two-dimensional code to the first control terminal.

After receiving the booting two-dimensional code transmitted by the cloud, the administrator computer will transmit the booting two-dimensional code to the corresponding user mobile phone. Furthermore, the administrator computer may be controlled to transmit the booting two-dimensional code through the administrator's triggering operation, or the administrator computer may be set to automatically perform the transmitting operation after receiving the booting two-dimensional code.

406. Scanning, by the television, the booting two-dimensional code of the first control terminal by using the camera.

When the user mobile phone is placed in the scanning area of the camera of the television, the camera of the television scans the screen of the user mobile phone to obtain the booting two-dimensional code displayed by the user mobile phone. After reading the booting two-dimensional code, the television stores the booting two-dimensional code in the data temporary storage area.

407. Determining whether the booting two-dimensional code is the same as the verification two-dimensional code stored in the television; if the booting two-dimensional code is the same as the verification two-dimensional code stored in the television, step 408 is performed; if the booting two-dimensional code is different from the verification two-dimensional code stored in the television, step 409 is performed.

The television matches the data of the currently obtained booting two-dimensional code with the verification two-dimensional code. If the booting two-dimensional code is the same as the verification two-dimensional code, it indicates that the user has obtained the usage permission of the current television from the administrator, and the user may turn on the television. If the booting two-dimensional code is different from the verification two-dimensional code, it indicates that the user has not obtained the usage permission of the current television, and the user cannot turn on the television. The above-described case where the booting two-dimensional code is the same as the verification two-dimensional code is an example of the data of the booting two-dimensional code matching the verification two-dimensional code, and the above-described case where the booting two-dimensional code is different from the verification two-dimensional code is an example of the data of the booting two-dimensional code not matching the verification two-dimensional code.

408. Obtaining a turning-on time length according to the booting two-dimensional code, and booting the television according to the turning-on time length.

After determining that the user has the permission to use the television, the television is turned on, the booting two-dimensional code is analyzed to obtain the turning-on time length requested by the user, and then the current turning-on time length of the television is set according to the turning-on time length.

409. Transmitting, by the television, an error prompt message to the first control terminal.

In order to prevent the user mobile phone from sending an incorrect booting request due to a misoperation or the like, or avoid the problem that the current television cannot be turned on because the user selects the wrong television, the television will transmit an error prompt message to the user mobile phone after determining that it cannot be turned on according to the current booting two-dimensional code.

Furthermore, when transmitting the booting request, the user mobile phone may also transmit the information of the user mobile phone or the information of the user to the administrator computer. In case of determining that the error prompt message needs to be transmitted to the user mobile phone, the television obtains the information of the user mobile phone or the information of the user from the administrator computer, so as to transmit an error prompt message to the corresponding user mobile phone according to the information of the user mobile phone or the information of the user. Alternatively, after receiving the information of the user mobile phone or the information of the user, the administrator computer transmits the information of the user mobile phone or the information of the user to the cloud for storage, so that the television obtains the information of the user mobile phone or the information of the user from the cloud in case of determining that the error prompt message needs to be transmitted to the user mobile phone. The information of the user mobile phone may be the mobile phone number, the MAC address of the mobile phone, and the like. The information of the user may be the name of the user, the account name and serial number of the user in the television administration system, and the like. In this embodiment, the content of the information of the user mobile phone and the information of the user are not specifically limited.

According to the method of booting the television provided by at least some embodiments of the present disclosure, in order not to affect the response speed of the second control terminal, the booting two-dimensional code of the television is stored in the cloud; and after receiving the booting request transmitted by the first control terminal and determining that the booting request is legal, the second control terminal directly obtains the corresponding booting two-dimensional code from the cloud. In order to enable the television to correctly verify the booting two-dimensional code of the first control terminal after receiving it, the booting two-dimensional code transmitted by the cloud to the second control terminal is also transmitted to the corresponding television as the verification two-dimensional code. And in order to remind the user in a case where the incorrect booting two-dimensional code is received, the television transmits an error prompt message to the first control terminal in case of determining that the received booting two-dimensional code is different from the verification two-dimensional code.

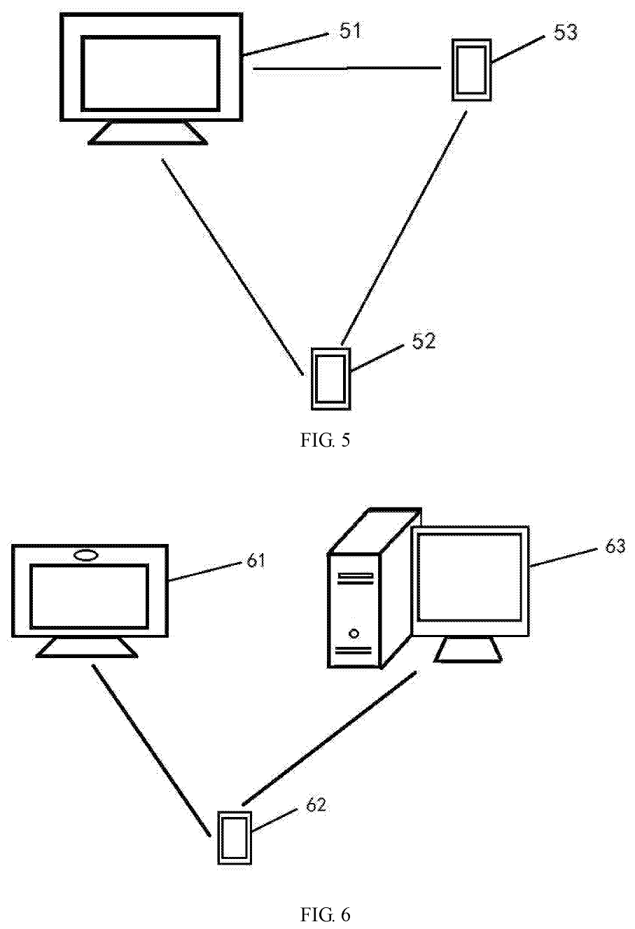

Based on the method of booting the television of the above embodiment, at least some embodiments of the present disclosure provide a control system of a television. Referring to FIG. 5, the system mainly includes a television 51, a first control terminal 52, and a second control terminal 53.

The television 51 is configured to display a booting two-dimensional code on a screen, the booting two-dimensional code corresponds to a preset booting instruction, and the preset booting instruction includes at least the turning-on time length of the television 51. The above-mentioned screen is a specific example of the display screen of the television 51.

The first control terminal 52 is configured to scan the booting two-dimensional code on the screen, and transmit the booting request of the television 51 to the second control terminal 53 according to the scanned booting two-dimensional code.

The second control terminal 53 is configured to generate a booting command of the television 51 according to the received booting request, and transmit the booting command to the television 51.

The television 51 is further configured to determine the turning-on time length according to a matching result of the booting command and the preset booting instruction.

The first control terminal 52 may be a terminal device such as a mobile phone or a tablet computer, and the second control terminal 53 may be a terminal device such as a mobile phone, a tablet computer, a desktop computer, and the like. The following description is made only by taking the case where the first control terminal 52 and the second control terminal 53 are mobile phones as an example, but the types of the first control terminal 52 and the second control terminal 53 are not limited by the embodiment.

The television 51 of the system stores a booting two-dimensional code and a preset booting instruction, the booting two-dimensional code corresponds to the preset booting instruction, and the preset booting instruction includes at least the turning-on time length of the television 51. It should be understood that the preset booting instruction including the turning-on time length of the television is only an example of the turning-on time length of the television corresponding to the preset booting instruction, and embodiments of the present disclosure are not limited thereto. After powered on, the television 51 will enter the standby mode, and the booting two-dimensional code is displayed on the standby page, wherein each booting two-dimensional code corresponds to one turning-on time length of the television. The user scans the corresponding booting two-dimensional code by the user mobile phone according to the required turning-on time length, and the user mobile phone generates a booting request according to the turning-on time length corresponding to the scanned two-dimensional code, and transmits the booting request to the corresponding administrator mobile phone. After receiving the booting request transmitted by the user mobile phone, the administrator mobile phone generates a booting command of the television 51 according to the turning-on time length carried in the booting request, and then transmits the booting command to the scanned television 51. Finally, after receiving the booting command transmitted by the administrator mobile phone, the television 51 compares the booting command with the preset booting instruction stored in the television 51. If the two may match, it indicates that the turning-on time length carried in the booting command is consistent with the preset turning-on time length in the television 51, and the booting command may be executed. Upon determining that the received booting command may be executed, the television 51 is switched to the play mode and plays the television program within the turning-on time length requested by the user. The television 51 includes, but is not limited to, a smart TV, and the type of the television 51 is not specifically limited in this embodiment. It should be understood that the booting command carrying the turning-on time length is only an example of the booting command corresponding to the turning-on time length of the television, and embodiments of the present disclosure are not limited thereto.

Furthermore, in order to facilitate the management and retrieval of data, a two-dimensional code picture library is preset in the television 51, and the television 51 generates a booting two-dimensional code according to the preset turning-on time length, and then stores the generated booting two-dimensional code in the two-dimensional code picture library of the television 51; the booting data storage area is preset in the television 51, the preset booting instruction is generated according to the preset turning-on time length that generating the booting two-dimensional code, and then the generated preset booting instruction is stored in the booting data storage area. A data temporary storage area is preset in the television 51, and the received booting command is stored in the data temporary storage area.

Furthermore, the user mobile phone may transmit the booting request to the corresponding administrator mobile phone according to the information input by the user; Alternatively, when the booting two-dimensional code carries the information of the administrator mobile phone or the administrator, the user mobile phone may transmit the booting request to the corresponding administrator mobile phone according to the information.

Furthermore, when the identifier of the television is included in the booting two-dimensional code, the identifier of the television may be added to the booting request, so that the administrator may determine the television 51 that the user requests to turn on after receiving the booting request. Alternatively, the user mobile phone may prompt the user to input the identifier of the television when generating the booting request.

Optionally, the television 51 is further configured to set each booting two-dimensional code to correspond to a unique turning-on time length of the television, and further configured to display all the booting two-dimensional codes on the turning-on time length selection page of the television 51.

In order to simplify the operation steps and reduce the selection error of the user, one booting two-dimensional code is generated for each turning-on time length so that one booting two-dimensional code corresponds to a unique turning-on time length. The standby page of the television 51 is set as the turning-on time length selection page, so that all the booting two-dimensional codes are displayed on the turning-on time length selection page, which enables the user to select the unique corresponding booting two-dimensional code according to the requested turning-on time length.

Optionally, the second control terminal 53 is further configured to receive a response result of the booting request, and the response result includes allowing booting the television and denying booting the television, and further configured to generate the booting command of the television 51 according to the booting request when the response result is allowing booting the television.

After receiving the booting request transmitted by the user, the administrator mobile phone waits to receive the response result manually made by the administrator to the booting request, or receive the response result automatically made to the booting request according to the preset judgment strategy; then, the subsequent operations are performed according to the response result. If the response result is allowing booting the television, the television 51 is controlled to be turned on for the user, that is, the corresponding booting command of the television 51 is generated according to the received booting request. If the response result is denying booting the television, the administrator mobile phone will not perform any operations according to the received booting request.

Optionally, the television 51 is further configured to transmit an error prompt message to the second control terminal 53 when a preset booting instruction matching the booting command is not found.

If a preset booting instruction which is the same as the received booting command is not found, the booting command received by the television 51 is an incorrect command and cannot be executed; the error needs to be reported to the administrator, that is, the error prompt message regarding the booting command is transmitted to the administrator mobile phone. The error prompt message may be a short message, a reminder message in the system or the program, etc., and the content and display form of the error prompt message are not specifically limited in this embodiment.

The control system of the television 51 of the present embodiment is applied to a home scenario, in which the child is the user and the parent is the administrator. After completing the task assigned by the parent, the child switches on the television 51 and scans the corresponding booting two-dimensional code on the screen of the television 51 by a user mobile phone according to the watching time of the television, and the user mobile phone generates a corresponding booting request according to the booting two-dimensional code and transmit the booting request to the corresponding administrator mobile phone. After receiving the booting request, the administrator mobile phone obtains the turning-on time length requested by the booting request and related information, displays the turning-on time length and related information, and waits for the parent to respond to the booting request. The related information includes information of the television 51 that is requested to be turned on, information of the child who transmit the booting request, and the like. When determining that the child has completed the task, the parent will click on the administrator mobile phone to allow booting the television, and the administrator mobile phone will generate a booting command according to the received booting request and transmit the booting command to the television 51 requested to be turned on. When determining that the child has not completed the task, the parent will click on the administrator mobile phone to deny booting the television, and the administrator mobile phone will transmit a feedback message to the user mobile phone to remind the child that the proposed booting request of the television 51 has been denied by the parent. After receiving the booting command and determining that there is a preset booting instruction which is the same as the booting command, the television 51 will be turned on according to the booting command, and the playing time of the current television 51 will be set according to the turning-on time length included in the booting command. However, after determining that there is no preset booting instruction which is the same as the booting command, the television 51 will not be turned on, and an error prompt message will be transmitted to the administrator mobile phone to remind the parent that the incorrect booting command is transmitted.

According to the control system of the television provided by at least some embodiments of the present disclosure, in order to improve the efficiency of setting the on/off time of the television by the user, a plurality of booting two-dimensional codes including different preset turning-on time length of the television are stored in the television 51 of the system. Moreover, in order to simplify the operation steps and reduce the selection error of the user, one booting two-dimensional code is set to correspond to a unique turning-on time length, and all the booting two-dimensional codes are displayed on the turning-on time length selection page of the television 51. Then, when wishing to turn on the television 51, the user may select and scan the corresponding booting two-dimensional code on the screen through the first control terminal 52 according to the watching time required by the user, and then the first control terminal 52 may generate a corresponding booting request according to the booting two-dimensional code. After obtaining the booting request, the second control terminal 53 may determine whether to generate a booting command of the television 51 for the booting request according to the received response result to the request. When the received response result is allowing booting the television, the second control terminal 53 will generate the booting command transmitted to the television 51 according to the booting request. In case of determining that the booting command is the same as the preset booting instruction, the television 51 is turned on and the turning-on time length that meets the user's needs is set according to the booting command. Furthermore, in case of determining that the received booting command does not match the preset booting instruction, the television 51 may transmit an error prompt message to the second control terminal 53 to remind the administrator that an incorrect command is transmitted.

At least some embodiments of the present disclosure also provide a control system of a television. Referring to FIG. 6, the system mainly includes a television 61, a first control terminal 62, and a second control terminal 63.

The first control terminal 62 is configured to obtain the booting two-dimensional code of the television 61 from the second control terminal 63;

The booting two-dimensional code in the second control terminal corresponds to the verification two-dimensional code stored in the television 61, and the booting two-dimensional code includes at least the turning-on time length of the television 61;

The television 61 is configured to scan a booting two-dimensional code of the first control terminal by using a camera, and determine whether to turn on the television 61 according to a matching result between the booting two-dimensional code and the verification two-dimensional code. It should be understood that the booting two-dimensional code including the turning-on time length of the television is only an example of the booting two-dimensional code corresponding to the turning-on time length of the television, and embodiments of the present disclosure are not limited thereto. In addition, it should be understood that the above-described camera is only an example of the imaging device of the television 61, and embodiments of the present disclosure are not limited thereto.

The first control terminal 62 may be a terminal device such as a mobile phone, or a tablet computer, and the like. The second control terminal 63 may be a terminal device such as a mobile phone, a tablet computer, or a desktop computer, and the like. The following description is made only by taking the case where the first control terminal 62 is a mobile phone and the second control terminal 63 is a computer as an example, but the type of the first control terminal 62 and the second control terminal 63 are not specifically limited in this embodiment.

When the television 61 in the system has a camera, the television 61 may scan the booting two-dimensional code on the user mobile phone to determine whether to be turned on for the user. If it is required to turn on the television 61, the user may obtain the booting two-dimensional code from the administrator computer by the user mobile phone. The verification code two-dimensional code is stored in the television 61, and the booting two-dimensional code in the administrator computer corresponds to the verification two-dimensional code, so after the user mobile phone obtains and displays the booting two-dimensional code, the television 61 scans and obtains the booting two-dimensional code displayed on the user mobile phone by the camera, and then matches the booting two-dimensional code with the stored verification two-dimensional code. If the booting two-dimensional code matches the stored verification two-dimensional code, it indicates that the booting two-dimensional code is obtained by the user mobile phone from the administrator computer corresponding to the television 61, that is, the user has obtained the permission from the administrator to use the television 61, and the television 61 may be turned on for the current user.

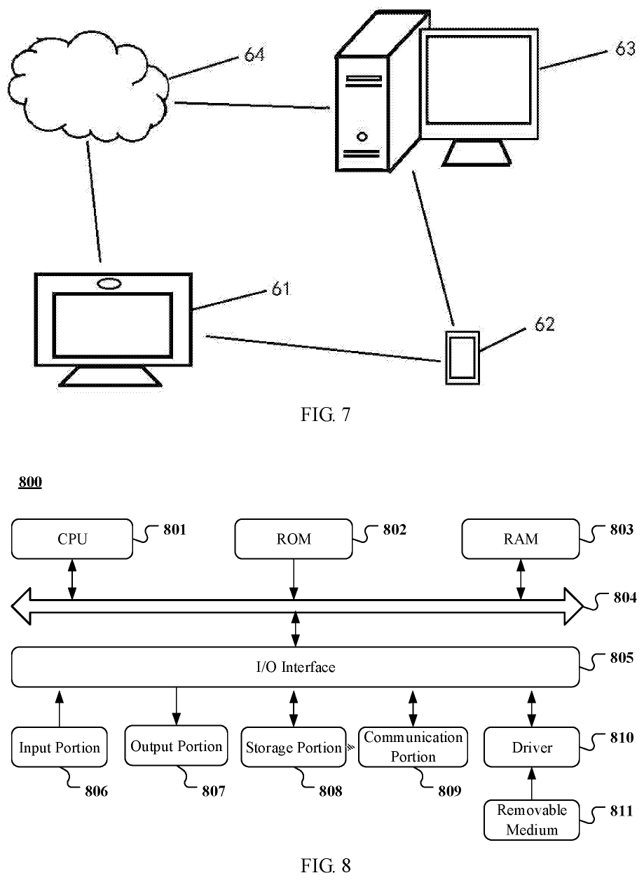

Optionally, referring to FIG. 7, the system further includes a cloud 64, and the dynamic two-dimensional code database of the cloud 64 stores booting two-dimensional codes corresponding to all turning-on time lengths.

In order not to occupy the storage space of the administrator computer and not to affect the response speed thereof, the booting two-dimensional code of the television is stored in the cloud 64. Furthermore, the dynamic two-dimensional code database of the cloud 64 stores the booting two-dimensional codes corresponding to all the turning-on time lengths, and the booting two-dimensional code is in one-to-one correspondence with the turning-on time length.

The first control terminal 62 is further configured to transmit a booting request to the second control terminal 63, and the booting request includes a turning-on time length requested by the first control terminal 62.

When obtaining the booting two-dimensional code from the administrator computer, the user mobile phone is required to first transmit a booting request to the administrator computer, and the booting request is generated by the user mobile phone according to the television 61 that the user request to turn on and the requested turning-on time length, so the booting request includes the requested turning-on time length.

Furthermore, the user mobile phone may transmit a booting request to the corresponding administrator computer according to the information input by the user; Alternatively, when the administration two-dimensional code of the information of the administrator's computer or the administrator is set on the television 61, the user mobile phone may obtain the information of the administrator computer or the administrator by scanning the administration two-dimensional code, and transmit the generated booting request to the corresponding administrator computer according to the obtained information.

The second control terminal 63 is further configured to obtain a corresponding booting two-dimensional code from the cloud 64 according to the booting request, and is further configured to transmit the booting two-dimensional code to the first control terminal 62.

After receiving the booting request, the administrator computer will obtain the turning-on time length requested in the booting request. When the booting request is required to be manually audited by the administrator, the administrator computer displays the information of the user and the turning-on time length requested by the user to the administrator, and waits to receive the response result of the administrator to the booting request. When the judging strategy is stored in the administrator computer, the administrator computer may respond to the obtained booting request according to the existing judgment strategy. When the response result is allowing booting the television, that is, when the booting two-dimensional code is required to be returned to the user mobile phone, the administrator computer obtains the booting two-dimensional code corresponding to the turning-on time length from the dynamic two-dimensional code database of the cloud 64, and then transmits the booting two-dimensional code to the corresponding user mobile phone. When the response result is denying booting the television, that is, the booting two-dimensional code is denied to be returned to the user mobile phone, a feedback message is transmitted to the corresponding user mobile phone to prompt the user that the request has been denied.

Optionally, the television 61 is further configured to receive the verification two-dimensional code transmitted by the cloud 64 after the second control terminal 63 obtains the corresponding booting two-dimensional code from the cloud 64 according to the booting request, where the verification two-dimensional code is the same as the booting two-dimensional code; the television 61 is further configured to store the verification two-dimensional code.

In order to enable the corresponding TV 61 to subsequently verify the booting two-dimensional code presented by the user mobile phone, the cloud 64 transmits the booting two-dimensional code as the verification two-dimensional code to the corresponding TV 61 after transmitting the two-dimensional code to the administrator computer. After receiving the verification two-dimensional code transmitted by the cloud 64, the television 61 stores the verification two-dimensional code in the data temporary storage area.

Optionally, the television 61 is further configured to obtain the turning-on time length according to the booting two-dimensional code when the booting two-dimensional code is the same as the verification two-dimensional code stored in the television 61, and turn on the television 61 according to the turning-on time length; the television 61 is further configured to transmit an error prompt message to the first control terminal 62 when the booting two-dimensional code is different from the verification two-dimensional code.

After scanning and obtaining the booting two-dimensional code of the user mobile phone by the camera, the television 61 first stores the booting two-dimensional code in the data temporary storage area, and then matches the booting two-dimensional code with the verification two-dimensional code stored in the television 61. If the booting two-dimensional code is the same as the verification two-dimensional code, it indicates that the user obtains the authority to use the current television 61, the television 61 may be turned on, and the turning-on time length of the television 61 may be set according to the turning-on time length in the booting two-dimensional code. If the booting two-dimensional code is different from the verification two-dimensional code, it indicates that the user has not obtained the authority to use the current TV 61, the television 61 cannot be turned on, and an error prompt message is transmitted to the user mobile phone to prompt the user that the television 61 cannot be turned on according to the current booting two-dimensional code.

The control system of the television of this embodiment is applied to a business scenario, in which the consumer is the user and the merchant is the administrator. After paying the merchant by means of mobile payment or the like, the consumer transmits a booting request to the administrator computer of the merchant by the user mobile phone. The judgment strategy stored in the administrator computer is to allow the user who has paid to use the television; after receiving the booting request, the response result to the booting request according to the judgment strategy is allowing booting the television, and then the corresponding booting two-dimensional code is obtained from the cloud 64 according to the turning-on time length requested by the booting request. The booting two-dimensional codes corresponding to all the turning-on time length are stored in the dynamic two-dimensional code database of the cloud 64, and after obtaining the corresponding booting two-dimensional code in the dynamic two-dimensional code database, the administrator computer transmits the booting two-dimensional code to the user mobile phone. After the user mobile phone receives the booting two-dimensional code, the consumer places the user mobile phone displaying the booting two-dimensional code in the scanning area of the camera of the television 61, and the television 61 may scan and obtain the booting two-dimensional code by the camera. After obtaining the booting two-dimensional code of the user, the television 61 compares the booting two-dimensional code with the verification two-dimensional code transmitted by the cloud 64. If the two two-dimensional codes are the same, the television 61 is turned on for the consumer, and the turning-on time length of the television 61 is set according to the turning-on time length in the booting two-dimensional code; if the two two-dimensional codes are different, the television 61 is not turned on, and an error prompt message is transmitted to the user mobile phone.

According to the control system of the television provided by at least some embodiments of the present disclosure, in order not to affect the response speed of the second control terminal 63, the booting two-dimensional code of the television 61 is stored in the cloud 64 of the system. When wishing to turn on the television 61, the user generates a booting request by the first control terminal 62 according to the required watching time length, and transmits the booting request to the second control terminal 63. After determining that the booting request is legal, the second control terminal 63 directly obtains the corresponding booting two-dimensional code from the cloud 64, and return the booting two-dimensional code to the first control terminal 62. Moreover, in order to enable the television 61 to correctly verify the booting two-dimensional code of the first control terminal 62 after receiving the booting two-dimensional code of the first control terminal 62, the booting two-dimensional code transmitted by the cloud 64 to the second control terminal 63 is also transmitted to the corresponding TV 61 as the verification two-dimensional code. After receiving the booting two-dimensional code, the first control terminal 62 causes the television 61 to scan and verify the booting two-dimensional code, and after the booting two-dimensional code is verified to be valid by the television, the turning-on time length of the television 61 that meets the user's requirements is set. And when the booting two-dimensional code is verified to be invalid, the television 61 transmits an error prompt message to the first control terminal 62 to prompt the user that the two-dimensional code is incorrect and the television 61 cannot be used.

Next, referring to FIG. 8, a schematic structural diagram of a computing system 800 suitable for implementing a method of booting a television or a television of at least some embodiments of the present disclosure is shown.

As shown in FIG. 8, the computing system 800 includes a central processing unit (CPU) 801 that may perform various appropriate operations and processes in accordance with a program stored in a read only memory (ROM) 802 or a program loaded from the storage portion 808 into the random access memory (RAM) 803. Various programs and data required for operations of the system 800 are also stored in the RAM 803. The CPU 801, the ROM 802, and the RAM 803 are connected to each other through a bus 804. An input/output (I/O) interface 805 is also connected to the bus 804.

The following components are connected to the I/O interface 805: an input portion 806 including a keyboard, a mouse, an imaging device such as a camera, and the like; an output portion 807 including a cathode ray tube display screen, a liquid crystal display, etc., and a speaker, and the like; the storage portion 808 including a hard disk, etc.; and a communication portion 809 including a network interface card such as a LAN card, a modem, and the like. The communication portion 809 performs communication processing via a network such as the Internet. A driver 810 is also connected to I/O interface 805 as required. A removable medium 811, such as a magnetic disk, an optical disk, a magneto-optical disk, a semiconductor memory or the like, is installed on the driver 810 as required, so that the computer program read therefrom is installed into the storage portion 808 as required.

In particular, according to an embodiment of the present disclosure, the processes described above with reference to FIGS. 1-4 may be implemented is a computer software program. For example, an embodiment of the present disclosure includes a computer program product comprising a computer program tangibly embodied on a machine readable medium, where the computer program comprises program code for performing the methods of FIGS. 1-4. In such an embodiment, the computer program may be downloaded and installed from the network via the communication portion 809, and/or installed from the removable media 811.

The flowchart and block diagrams in the figures illustrate the architectures, functionalities, and operations of possible implementations of systems, methods, and computer program products in accordance with various embodiments of the present disclosure. In this regard, each block of the flowchart or block diagrams may represent a module, a program segment, or a portion of code that includes one or more executable instructions for implementing the specified logical functions. It should also be noted that in some alternative implementations, the functions noted in the blocks may also occur in a different order than that illustrated in the drawings. For example, two successively represented blocks may in fact be executed substantially in parallel, and they may sometimes be executed in a reverse order, which depends upon the functionality involved. It is also noted that each block of the block diagrams and/or flowcharts, and combinations of blocks in the block diagrams and/or flowcharts, may be implemented by a dedicated hardware-based system that performs the specified function or operation, or may be implemented by a combination of dedicated hardware and computer instructions.

The units or modules described in the embodiments of the present application may be implemented in software or in hardware. The described unit or module may also be provided in the processor. The names of these units or modules do not in any way constitute a limitation on the unit or module itself.

In the above embodiments, the descriptions of the various embodiments have different emphases, and the details that are not described in a certain embodiment may be referred to the related descriptions of other embodiments.

It will be appreciated that related features in the above described devices may be refer to each other. In addition, “first,” “second,” and the like in the above embodiments are used to distinguish the embodiments, and do not represent the advantages and disadvantages of the embodiments.

In the description provided herein, numerous specific details are set forth. However, it is understood that the embodiments of the present disclosure may be practiced without these specific details. In some examples, well-known structures and techniques have not been shown in detail so as not to obscure the understanding of the description.

Similarly, it is understood that in the above description of the exemplary embodiments of the present disclosure, various features of the present disclosure are sometimes grouped together in a single embodiment, figure, or a description thereof, so as to clarify the present disclosure and to facilitate understanding of one or more of the various inventive aspects. However, the disclosed apparatus should not be construed as reflecting the intention that the claimed invention requires more features than those specifically recited in the claims. Rather, as the following claims reflect, inventive aspects reside in fewer features than the single embodiments disclosed herein. Therefore, the claims following the specific embodiments are hereby explicitly incorporated into the specific embodiments, and each of the claims as a separate embodiment of the present disclosure.

It should be understood by those skilled in the art that the components of the apparatus in the embodiments may be adaptively changed and placed in one or more devices different from the embodiment. The components of the embodiment may be combined into one component and, in addition, may be divided into a plurality of sub-components. In addition to at least some of such features which are mutually exclusive, all of the features disclosed in the specification (including the accompanying claims, the abstract, and the drawings) and all components of any device so disclosed may be combined in any combination. Unless explicitly stated otherwise, each feature disclosed in this specification (including the accompanying claims, the abstract, and the drawings) may be replaced by the alternative features that provide the same, equivalent or similar purpose.

In addition, it should be understood by those skilled in the art that, although some embodiments described herein include some of the features of other embodiments, rather than other features, combinations of features of different embodiments are intended to be within the scope of the present disclosure and to form different embodiments. For example, in the following claims, any one of the claimed embodiments may be used in any combination. Various component embodiments of the present disclosure may be implemented in hardware or in a combination thereof.

It should be noted that the above-described embodiments are illustrative of the present disclosure and are not intended to limit the scope of the disclosure, and those skilled in the art may devise alternative embodiments without departing from the scope of the appended claims. In the claims, any reference signs placed between parentheses shall not be construed as a limitation. The word “comprising” does not exclude the presence of a part or a component that is not listed in the claims. The word “a” or “an” preceding a part or component does not exclude the presence of a plurality of such components or components. The present disclosure may be implemented by means of a device comprising several distinct components. In the claims enumerating several components, several of these components may be embodied by the same component. The use of the words first, second, and third does not indicate any order, and these words may be interpreted as names.

The forgoing is only exemplary embodiments of the present disclosure, and is not intended to limit the scope of the disclosure. The scope of the disclosure is determined by the appended claims.

The embodiment of the present disclosure also discloses the following technical solutions:

A1. A method of booting a television, the method comprising:

displaying at least one booting two-dimensional code on a screen of the television, the booting two-dimensional code corresponding to a preset booting instruction, and the preset booting instruction including at least a turning-on time length of the television;

scanning, by a first control terminal, the booting two-dimensional code, and transmitting, by the first control terminal, a booting request of the television to a second control terminal according to the booting two-dimensional code;

generating, by the second control terminal, a booting command of the television according to the booting request, and transmitting, by the second control terminal, the booting command to the television;

determining, by the television, a turning-on time length according to a matching result between the booting command and the preset booting instruction.

A2. The method according to A1, the displaying at least one booting two-dimensional code on the screen of the television comprises:

setting each booting two-dimensional code to correspond to a unique turning-on time length of the television;

displaying all the booting two-dimensional codes on a turning-on time length selection page of the television.

A3. The method according to A1 or A2, the generating, by the second control terminal, the booting command of the television according to the booting request comprises:

receiving, by the second control terminal, a response result of the booting request, the response result including allowing booting the television and denying booting the television;

generating, by the second control terminal, the booting command of the television according to the booting request, in a case where the response result is allowing booting the television.

A4. The method according to A1, further comprising:

transmitting, by the television, an error prompt message to the second control terminal, in a case where the preset booting instruction matching the booting command is not found.

B5. A method of booting a television, the method comprising:

obtaining, by a first control terminal, a booting two-dimensional code of the television from a second control terminal, the booting two-dimensional code in the second control terminal corresponding to a verification two-dimensional code stored in the television, and the booting two-dimensional code including at least a turning-on time length of the television;

scanning, by the television, the booting two-dimensional code of the first control terminal by using a camera, and determining whether to turn on the television according to a matching result between the booting two-dimensional code and the verification two-dimensional code.

B6. The method according to B5, the obtaining, by the first control terminal, the booting two-dimensional code of the television from the second control terminal comprising:

transmitting, by the first control terminal, a booting request to the second control terminal, the booting request including a turning-on time length requested by the first control terminal;

obtaining, by the second control terminal, a corresponding booting two-dimensional code from a cloud according to the turning-on time length, and a dynamic two-dimensional code database of the cloud storing booting two-dimensional codes corresponding to all the turning-on time lengths;

transmitting, by the second control terminal, the booting two-dimensional code to the first control terminal.

B7. The method according to B6, subsequent to obtaining, by the second control terminal, the corresponding booting two-dimensional code from the cloud according to the booting request, the method further includes:

receiving, by the television, a verification two-dimensional code transmitted by the cloud, the verification two-dimensional code being the same as the booting two-dimensional code;

storing, by the television, the verification two-dimensional code.

B8. The method according to any one of B5-B7, the determining whether to turn on the television according to the matching result between the booting two-dimensional code and the verification two-dimensional code comprises:

obtaining a turning-on time length according to the booting two-dimensional code, and booting the television according to the turning-on time length, in a case where the booting two-dimensional code is the same as the verification two-dimensional code stored in the television;

transmitting, by the television, an error prompt message to the first control terminal, in a case where the booting two-dimensional code is different from the verification two-dimensional code.

C9. A television control system, wherein the system comprises a television, a first control terminal and a second control terminal:

the television is configured to display a booting two-dimensional code on a screen, wherein the booting two-dimensional code corresponds to a preset booting instruction, and the preset booting instruction includes at least the turning-on time length of the television;

the first control terminal is configured to scan a booting two-dimensional code on the screen, and transmit a booting request of the television to the second control terminal according to the scanned booting two-dimensional code;

the second control terminal generates a booting command of the television according to the received booting request, and transmits the booting command to the television;

the television is further configured to determine a turning-on time length according to a matching result between the booting command and the preset booting instruction.

C10. The system according to C9, the television is further configured to set each booting two-dimensional, code to correspond to a unique turning-on time length of the television, and is further configured to display all the booting two-dimensional codes on a turning-on time length selection page of the television.

C11. The system according to C9 or C10, the second control terminal is further configured to receive a response result of the booting request, the response result includes allowing booting the television and denying booting the television, and the second control terminal is further configured to generate a booting command of the television according to the booting request in a case where the response result is allowing booting the television.

C12. The system according to C9, the television is further configured to transmit an error prompt message to the second control terminal in a case where a preset booting instruction matching the booting command is not found.

D13. A television control system, wherein the system comprises a television, a first control terminal, and a second control terminal:

the first control terminal is configured to obtain a booting two-dimensional code of the television from the second control terminal;

the booting two-dimensional code in the second control terminal corresponds to a verification two-dimensional code stored in the television, and the booting two-dimensional code includes at least the turning-on time length of the television;

the television is configured to scan the booting two-dimensional code of the first control terminal by using a camera, and determine whether to turn on the television according to a matching result between the booting two-dimensional code and the verification two-dimensional code.

D14. The system of D13, the system further comprises a cloud,

a dynamic two-dimensional code database of the cloud stores booting two-dimensional codes corresponding to all the turning-on time lengths;

the first control terminal is further configured to transmit a booting request to the second control terminal, wherein the booting request includes a turning-on time length requested by the first control terminal;

the second control terminal is further configured to obtain a corresponding booting two-dimensional code from the cloud according to the booting request, and the second control terminal is further configured to transmit the booting two-dimensional code to the first control terminal.

D15. The system according to D14, the television is further configured to, after the second control terminal obtains the corresponding booting two-dimensional code from the cloud according to the booting request, receive the verification two-dimensional code transmitted by the cloud, wherein the verification two-dimensional code is the same as the booting two-dimensional code; the television is further configured to store the verification two-dimensional code.

The system of any one of D13-D15, wherein the television is further configured to, in a case where the booting two-dimensional code is the same as the verification two-dimensional code stored in the television, obtain the turning-on time length according to the booting two-dimensional code, and the television is turned on according to the turning-on time length; the television is further configured to transmit an error prompt message to the first control terminal in a case where the booting two-dimensional code is different from the verification two-dimensional code.

1-10. (canceled)

11. A method of operating an electronic device, the method comprising:
obtaining graphic code information about a predetermined operation of the electronic device;
obtaining instruction information about the predetermined operation of the electronic device; and
operating the electronic device according to a matching result between the graphic code information and the instruction information.

12. The method according to claim 11, wherein
the obtaining the graphic code information about the predetermined operation of the electronic device comprises: obtaining the graphic code information stored in the electronic device,
the method further comprises: providing the graphic code information to a first control terminal,
the obtaining the instruction information about the predetermined operation of the electronic device comprises:
obtaining the instruction information from a second control terminal, wherein the instruction information is generated by the second control terminal based on a request of the first control terminal, and the request is generated by the first control terminal based on the graphic code information, and
the operating the electronic device according to the matching result between the graphic code information and the instruction information comprises:
comparing the instruction information with preset instruction information corresponding to the graphic code information, and
operating the electronic device based on a result of the comparing.

13. The method according to claim 11, wherein
the obtaining the graphic code information about the predetermined operation of the electronic device comprises: scanning a graphic code about the predetermined operation of the electronic device on a first control terminal to obtain the graphic code information, and
the obtaining the instruction information about the predetermined operation of the electronic device comprises: obtaining the instruction information stored in the electronic device.

14. The method according to claim 13, wherein the graphic code is provided by a second control terminal to the first control terminal based on a request of the first control terminal.

15. The method according to claim 13, further comprising:
receiving the instruction information transmitted by a cloud in response to a request of the second control terminal; and
storing the instruction information.

16. The method according to claim 13, wherein
the operating the electronic device according to the matching result between the graphic code information and the instruction information comprises:
performing a predetermined operation corresponding to the graphic code information, in response to the graphic code information matching the instruction information; and
transmitting an error prompt message, in response to the graphic code information not matching the instruction information.

17. A method of controlling an electronic device, the method comprising:
receiving a request from a first control terminal;
providing, according to the request from the first control terminal, a first graphic code to the first control terminal so that the first control terminal provides graphic code information to the electronic device, wherein the first graphic code comprises the graphic code information, and the graphic code information is about a predetermined operation of the electronic device; or
providing, according to the request from the first control terminal, instruction information to the electronic device, wherein the request is based on the first graphic code which comprises the graphic code information about the predetermined operation of the electronic device.

18. (canceled)

19. A control terminal, comprising:
a processor; and
a memory,
wherein the memory stores computer readable instructions executable by the processor, and the computer readable instructions, when executed, cause the processor to perform operations comprising:
receiving a request from a first control terminal;
providing, according to the request from the first control terminal, a first graphic code to the first control terminal so that the first control terminal provides graphic code information to an electronic device, wherein the first graphic code comprise the graphic code information, and the graphic code information is about a predetermined operation of the electronic device; or
providing, according to the request from the first control terminal, instruction information to the electronic device, wherein the request is based on the first graphic code comprising the graphic code information about the predetermined operation of the electronic device.

20. An electronic device control system, comprising an electronic device and the control terminal according to claim 19,
wherein the electronic device comprises:
a second processor; and
a second memory,
wherein the second memory stores second computer readable instructions executable by the processor, and the second computer readable instructions, when executed, cause the second processor to perform second operations comprising:
obtaining second graphic code information about a predetermined operation of the electronic device;
obtaining second instruction information about the predetermined operation of the electronic device; and
operating the electronic device according to a matching result between the second graphic code information and the second instruction information.

21. The method according to claim 17, wherein the providing, according to the request from the first control terminal, the first graphic code to the first control terminal so that the first control terminal provides the graphic code information to the electronic device comprises:
obtaining the first graphic code from a cloud, according to the request from the first control terminal; and
transmitting the first graphic code obtained from the cloud to the first control terminal.

22. The method according to claim 17, wherein the providing, according to the request from the first control terminal, the instruction information to the electronic device comprises:
receiving a response result of the request;
generating the instruction information according to the request; and
transmitting the instruction information to the electronic device.

23. The method according to claim 17, wherein the predetermined operation of the electronic device comprises: booting the electronic device.

24. The method according to claim 17, wherein each of the first control terminal and the second control terminal comprises a portable terminal device.

25. The method according to claim 17, wherein the electronic device comprises a television.

26. The electronic device control system according to claim 20, wherein in a case where the operations comprise providing, according to the request from the first control terminal, the instruction information to the electronic device:
the obtaining the second graphic code information about the predetermined operation of the electronic device comprises: obtaining the second graphic code information stored in the electronic device,
the second operations further comprise: providing the second graphic code information to the first control terminal
the obtaining the second instruction information about the predetermined operation of the electronic device comprises: obtaining the instruction information from the control terminal as the second instruction information, and
the operating the electronic device according to the matching result between the second graphic code information and the second instruction information comprises:
comparing the second instruction information with preset instruction information corresponding to the second graphic code information, and
operating the electronic device based on a result of the comparing.

27. The electronic device control system according to claim 20, wherein in a case where the operations comprise providing, according to the request from the first control terminal, the first graphic code to the first control terminal so that the first control terminal provides the graphic code information to the electronic device:
the graphic code information is the second graphic code information,
the obtaining the second graphic code information about the predetermined operation of the electronic device comprises: scanning a graphic code about the predetermined operation of the electronic device on the first control terminal to obtain the second graphic code information, and
the obtaining the second instruction information about the predetermined operation of the electronic device comprises: obtaining the second instruction information stored in the electronic device.

28. The electronic device control system according to claim 27, wherein the second operations further comprise:
receiving the second instruction information transmitted by a cloud in response to a request of the control terminal; and
storing the second instruction information.

29. The electronic device control system according to claim 27, wherein the operating the electronic device according to the matching result between the second graphic code information and the second instruction information comprises:
performing a predetermined operation corresponding to the second graphic code information, in response to the second graphic code information matching the second instruction information; and
transmitting an error prompt message, in response to the second graphic code information not matching the second instruction information.
